(19) United States
(12) Patent Application Publication
(10) Pub. No.: US 2008/0112563 A1
(43) Pub. Date: May 15, 2008

(54) APPARATUS AND METHOD FOR DYNAMIC CIPHERING IN A MOBILE COMMUNICATION SYSTEM

(75) Inventor: Kwang-Sik CHOI, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/874,664

(22) Filed: Oct. 18, 2007

(30) Foreign Application Priority Data
Nov. 15, 2006 (KR) 2006-0113026

(51) Int. Cl. H04L 9/16

(52) U.S. Cl. 380/44

(57) ABSTRACT

An apparatus and method for dynamic ciphering in a mobile communication system are provided. In a dynamic ciphering mobile communication system, a ciphering apparatus receives the Security Code Table (SCT) in advance and stores it, creates dynamic cipher keys when the data need to be ciphered using the SCT and the frame number of the data, and transmits the frame containing the data ciphered by the created dynamic cipher key, a deciphering apparatus receives the frame, creates the dynamic cipher key using the SCT and the frame number of the received frame, and deciphers the data contained in the frame using the dynamic cipher key created, and an authentication center manages authentication keys which are subscribers' authentication information, and creates and manages the SCTs of subscribers.

### PRIORITY

This application claims priority under 35 U.S.C. § 119 to an application filed in the Korean Intellectual Property Office on Nov. 15, 2006 entitled “Apparatus and Method for Dynamic Ciphering in a Mobile Communication System” and assigned Serial No. 2006-113026, the contents of which are herein incorporated by reference.

### BACKGROUND OF THE INVENTION

1. Field of the Invention

The present invention relates generally to an apparatus and method for dynamic ciphering in a mobile communication system, and in particular, to an apparatus and method for dynamically creating a cipher key according to frame number of data to transmit, and ciphering the data using the created cipher key in a mobile communication terminal.

2. Description of the Related Art

Today, portable terminals such as mobile communication terminals and Personal Digital Assistants (PDA), etc are widely used. The scope of their applications is ever widening. These portable terminals not only serve the purpose of simple telephone conversation or schedule management, but also provide functions for capturing still or moving images using a built-in digital camera, receiving satellite broadcast, editing documents, playing games, supporting navigation, listening music, Short Message Service (SMS) and banking services, and transmitting and receiving multimedia messages containing the captured images.

To support these diverse applications, a mobile communication system transmits and receives various forms of data, wherein data security is required to protect sensitive data such as personal information, as well as to guard subscribers' privacy.

Thus, conventional mobile communication systems incorporate schemes to cipher data being transmitted and received. The conventional ciphering scheme is explained below with reference to corresponding drawings.

FIG. 1 depicts the configuration of a ciphering apparatus of a conventional mobile communication terminal. Referring to FIG. 1, the ciphering apparatus of the conventional mobile communication terminal includes a key creation part 100 and a ciphering part 110.

Key creation part 100 creates a cipher key according to an algorithm using an authentication key (Ki) that identifies a mobile communication terminal and a random seed that becomes seed for cipher key creation. The authentication key, which is a unique information that identifies subscribers, can be stored in a SIM card, while the random seed is a variable value received from a deciphering apparatus to create the cipher key.

There are many known algorithms used for cipher key creation in key creation part 100, among which Algorithm 8 (A8) is representative. For details of A8, refer to the Standard Specification “GSM 03.20 version 5.1.1.”

Ciphering part 110 ciphers data according to a ciphering algorithm using the cipher key created in key creation part 100. For ciphering part 110, various ciphering algorithms may be used, among which Algorithm 5 (A5) is representative. For details of A5, refer to the Standard Specification “GSM 03.20 version 5.1.1.”

As described above, the ciphering apparatus in a conventional mobile communication terminal creates a cipher key using a random seed received from a Base Station System (BSS) or a Mobile Switching Center (MSC), which are deciphering apparatuses.

However, since the random seed is delivered to the mobile communication terminal over the air, security breach may occur wherein the ciphered data being transmitted may be deciphered by a malicious actor.

Accordingly, an apparatus and method to enhance the security of the ciphered data by frequently changing the cipher key is called for.

### SUMMARY OF THE INVENTION

An object of the present invention is to solve at least the above problems and/or disadvantages and to provide at least the advantages below. Accordingly, an object of the present invention is to provide an apparatus and method for dynamic ciphering in a mobile communication system.

Another object of the present invention is to provide an apparatus and method that ciphers data using a dynamic cipher key in a mobile communication system.

Another object of the present invention is to provide an apparatus and method that ciphers data using a dynamic cipher key that changes according to frame number of the data transmitted in a mobile communication system.

Another object of the present invention is to provide an apparatus and method that creates a dynamic cipher key using a Security Code Table (SCT), and ciphers data using the created dynamic cipher key in a mobile communication system.

According to an aspect of the present invention, a dynamic ciphering mobile communication system includes a ciphering apparatus for receiving and storing a SCT beforehand, creating a dynamic cipher key when data to transmit needs to be ciphered using the SCT and frame number of the data, and transmitting a frame containing the ciphered data; a deciphering apparatus for receiving the frame, creating a dynamic cipher key using the SCT and the frame number of the frame, and deciphering the ciphered data contained in the frame using the dynamic cipher key; and an authentication center for managing authentication keys which are subscribers' authentication information, and creating and managing the SCTs of subscribers.

According to another aspect of the present invention, a ciphering apparatus of a dynamic ciphering mobile communication system includes a dynamic key creation part for creating a dynamic cipher key that dynamically changes according to frame number by use of an authentication key, a random seed received from a deciphering apparatus, the frame number of data to be transmitted, and a SCT; and a ciphering part for creating ciphered data according to a ciphering algorithm that ciphers data to be transmitted using the dynamic cipher key created in the dynamic key creation part, and creating and transmitting the frame that contains the ciphered data.

According to a further aspect of the present invention, a deciphering apparatus of a dynamic ciphering mobile communication system includes a dynamic key creation part for creating a dynamic cipher key which dynamically changes according to frame number using an authentication key, a random seed transmitted to a ciphering apparatus, frame number of frame received from the ciphering apparatus, and a SCT; and a deciphering part for deciphering ciphered data contained in the received frame according to a deciphering algorithm using the dynamic cipher key created in the dynamic key creation part.

According to still another aspect of the present invention, a dynamic ciphering method of a ciphering apparatus in a mobile communication system includes checking, when a data transmission event is sensed, a stored authentication key and a random seed received from a deciphering apparatus; creating a cipher key according to a key creation algorithm using the checked authentication key and the random seed; checking frame number of data to be transmitted; obtaining a frame seed corresponding to the frame number using a stored SCT; creating a dynamic cipher key according to the key creation algorithm using the cipher key and the frame seed; creating ciphered data according to a ciphering algorithm ciphering the data to transmit using the dynamic cipher key; and creating and transmitting the frame that contains the ciphered data.

According to yet another aspect of the present invention, a dynamic deciphering method of a deciphering apparatus in a mobile communication system includes checking, when a frame is received, whether a dynamic cipher key has been used; if so, checking the authentication key of a subscriber who transmitted the frame, and a random seed which has been created using random numbers and transmitted to the ciphering apparatus; creating a cipher key according to a key creation algorithm using the authentication key and the random seed; checking frame number of the frame received; obtaining a frame seed corresponding to the frame number using a stored SCT; creating a dynamic cipher key according to the key creation algorithm using the cipher key and the frame seed; and deciphering the ciphered data contained in the frame using the dynamic cipher key.

### BRIEF DESCRIPTION OF THE DRAWINGS

The above and other objects, features and advantages of the present invention will become more apparent from the following detailed description when taken in conjunction with the accompanying drawings in which:

FIG. 1 depicts the configuration of a ciphering apparatus that ciphers data in a conventional mobile communication terminal;

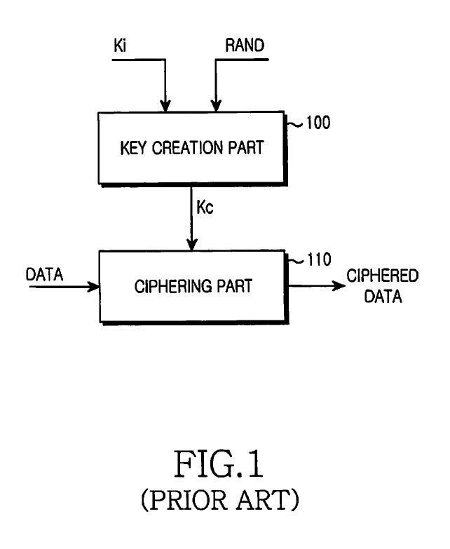

FIG. 2 depicts a simple configuration of a mobile communication system for ciphering and deciphering according to the present invention;

FIG. 3 is an overview of the internal configuration of a ciphering apparatus for ciphering data and transmitting the ciphered data and a deciphering apparatus for deciphering the ciphered data in a mobile communication system according to a preferred embodiment of the present invention;

FIG. 4 is an overview of the internal configuration of a dynamic key creation part that creates dynamic cipher keys in a mobile communication system according to the present invention;

FIG. 5 is a flowchart of a process of creating a dynamic cipher key and ciphering data in a ciphering apparatus of a mobile communication system according to the present invention; and

FIG. 6 is a flowchart of a process of creating a dynamic cipher key and deciphering ciphered data in a deciphering apparatus of a mobile communication system according to the present invention.

### DETAILED DESCRIPTION OF THE PREFERRED EMBODIMENT

The preferred embodiment of the present invention is described herein below with reference to the accompanying drawings. In the following description, well-known functions or constructions are not described in detail since they would obscure the invention in unnecessary detail.

The present invention provides an apparatus and method that dynamically creates a dynamic cipher key according to frame number of data and ciphers the data using the dynamic cipher key, when a ciphering apparatus ciphers data and transmit it in a mobile communication system. A configuration of the mobile communication system will be described below with reference to the drawings.

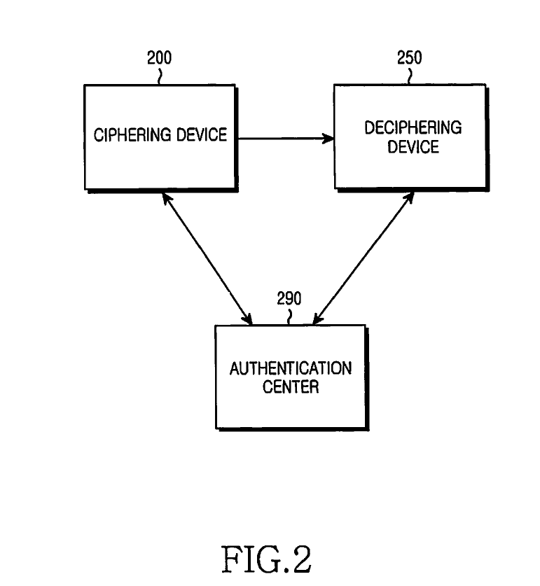

Referring to FIG. 2, the mobile communication system of the present invention includes a ciphering apparatus 200, a deciphering apparatus 250, and an authentication center (AuC) 290.

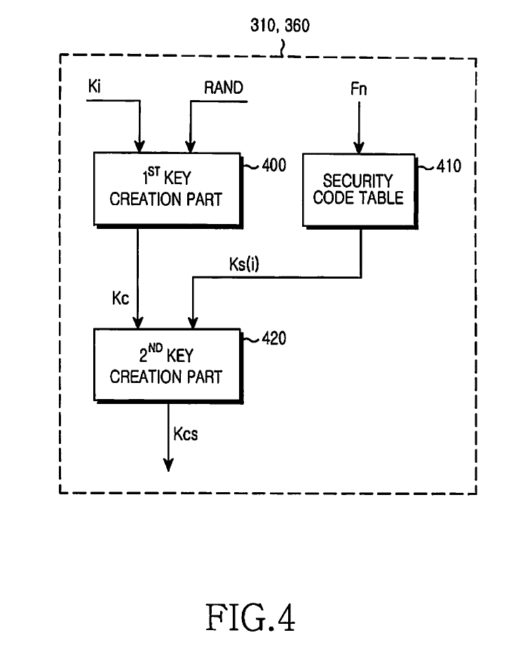

Ciphering apparatus 200, which may be implemented within a mobile communication terminal, receives and stores beforehand a SCT from authentication center 290, creates a dynamic cipher key using the SCT when data needs to be ciphered, ciphers the data with the created dynamic cipher key, and transmits the ciphered data. The method of creating a dynamic cipher key is explained herein below in detail with reference to FIG. 4.

Deciphering apparatus 250, which may be included in a Base Station System (BSS) and a Mobile Switching Center (MSC), receives the SCT from authentication center 290 and stores it, randomly creates and transmits a random seed for dynamic cipher key creation to the ciphering apparatus. Upon receipt of the ciphered data, deciphering apparatus 250 creates a dynamic cipher key using the SCT and deciphers ciphered data using the dynamic cipher key.

Authentication center 290 stores authentication keys which are authentication information of subscribers, creates the SCT and transmits it to ciphering apparatus 200 according to the request of ciphering apparatus 200, transmits the authentication keys of subscribers and the SCTs to deciphering apparatus 250, and stores and manages the authentication keys and the SCTs.

In addition, authentication center 290, when re-asked for the SCT from ciphering apparatus 200 does not retransmit the existing SCT for security purposes because the SCT has been deleted due to reasons such as initialization, rather ciphering apparatus 200 creates a new SCT and transmits it. A detailed description of the SCT is provided herein below with reference to FIG. 4.

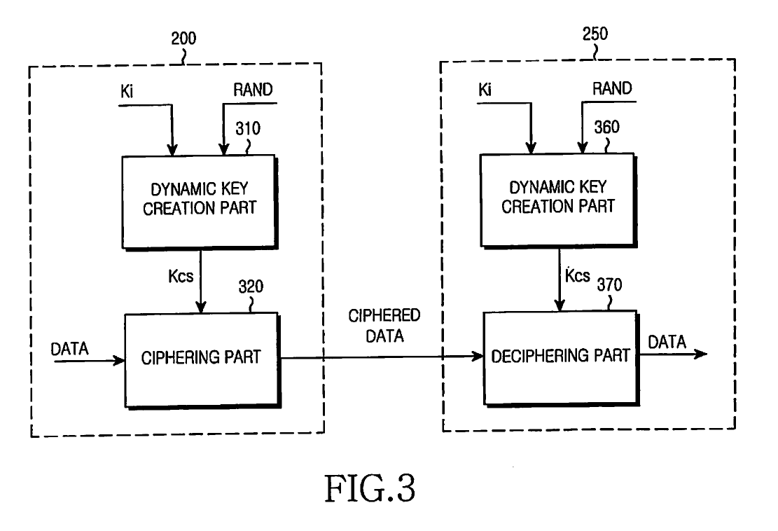

Referring to FIG. 3, ciphering apparatus 200 includes a dynamic key creation part 310 and a ciphering part 320, while the deciphering apparatus 250 includes a dynamic key creation part 360 and a deciphering part 370.

Dynamic key creation part 310 creates dynamic cipher keys that dynamically change according to the frame numbers, by use of an authentication key (Ki), a random seed (RAND) received from deciphering apparatus 250 that becomes the seed for the cipher key creation, frame number of the data to transmit, and the SCT received from authentication center 290. A detailed description of dynamic key creation part 310 is provided herein below with reference to FIG. 4.

Ciphering part 320 outputs the ciphered data using the dynamic cipher key created by dynamic key creation part 310. Various ciphering algorithms are available at ciphering part 320. The present invention uses Algorithm 5 (A5) as previously indicated.

Dynamic key creation part 360 creates dynamic cipher keys that dynamically change according to the frame numbers. To create the dynamic cipher keys, dynamic key creation part 360 uses a subscriber's authentication key (ki) received from authentication center 290, a random seed (RAND) created with random numbers and transmitted to ciphering apparatus 200 to become the seed for cipher key creation, frame number of the data received, and the SCT received from authentication center 290. A detailed description of dynamic key creation part 360 is provided herein below with reference to FIG. 4.

Deciphering part 370 deciphers the ciphered data according to the corresponding deciphering algorithm using the dynamic cipher key created by dynamic key creation part 360. Various algorithms are available for deciphering at deciphering part 370. The present invention uses the aforementioned Algorithm 5 (A5).

The dynamic key creation part is explained herein below in detail with reference to FIG. 4.

Referring to FIG. 4, dynamic key creation parts 310 and 360 include a 1^{st} key creation part 400, an SCT 410, and a 2^{nd} key creation part 420.

The 1^{st} key creation part creates a cipher key (Kc) according to the key creation algorithm using an authentication key (Ki) that identifies subscribers and a random seed (RAND) that becomes the seed for cipher key creation. Here, the authentication key (Ki) is the unique information identifying the subscribers and is stored in a SIM card. The random seed (RAND) is the variable value for creating the cipher key that is created and transmitted by deciphering apparatus 350.

SCT 410 is created by authentication center 290 for each subscriber, and is comprised of a set of random numbers as seen in Table 1 below.

TABLE 1

| Index | Code |
|---|---|
| 0 | 0x0123 |
| 1 | 0x1234 |
| 2 | 0x6854 |
| 3 | 0x5634 |
| 4 | 0x9721 |
| . | . |
| . | . |
| . | . |
| 5 | . . . |

SCT 410, when the frame number (Fn) is input, obtains the frame seed (Ks(i)) that corresponds to the remainder value obtained by performing the operation of the frame number (Fn) by the number of index as seen in Equation (1) below.

Ks((i)=Code(Fn%X) 1)

where, Ks(i) represents the frame seed, X represents the total number of the index, Fn represents the frame number, and Code(i) represents the code value of the SCT corresponding to the i^{th} index.

The 2^{nd} key creation part 420 creates a dynamic cipher key (Kcs) according to the key creation algorithm using the cipher key (Kc) created by the 1^{st} key creation part and the frame seed (Ks(i)) obtained through SCT 410.

Various key creation algorithms are available for use in the 1^{st} and the 2^{nd} key creation parts. In the case of the 1^{st} key creation part of the present invention, Algorithm 8 (A8) previously specified is used.

The dynamic ciphering method in the mobile communication system configured as described above according to the present invention is explained herein below with reference to drawings.

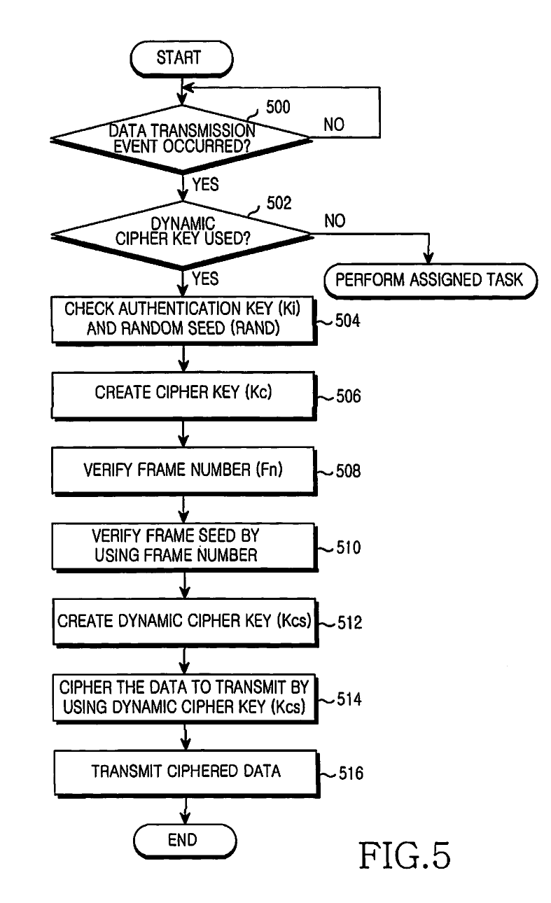

Referring to FIG. 5, the ciphering apparatus, when it senses a data transmission event at Step 500, proceeds to Step 502 to check if a dynamic cipher key is used. When the dynamic cipher key is not used, it performs the assigned task by either not ciphering or ciphering using the cipher key according to a conventional ciphering method.

If the dynamic cipher key is used, the ciphering apparatus proceeds to Step 504 to verify an authentication key (Ki) and a random seed (RAND) received from the deciphering apparatus to become the seed for cipher key creation. In Step 506, the ciphering apparatus creates a cipher key (Kc) according to the key creation algorithm using the authentication key (Ki) and the random seed (RAND). In Step 508, the ciphering apparatus verifies the frame number (Fn) of the data to be transmitted. In Step 510, the ciphering apparatus obtains a frame seed (Ks(i)) corresponding to the frame number (Fn) using the SCT received from the authentication center. In Step 512, the ciphering apparatus creates a dynamic cipher key (Kcs) according to the key creation algorithm using the cipher key (Kc) and the frame seed (Ks(i)).

Then, the ciphering apparatus proceeds to Step 514 to cipher the data to be transmitted according to the ciphering algorithm using the created dynamic cipher key (Kcs). In Step 516, the ciphering apparatus creates the frame containing the ciphered data and transmits it to the deciphering apparatus.

The header of the frame containing the ciphered data created by using the dynamic cipher key at Step 516 includes dynamic cipher key usage information, indicating that the dynamic cipher key has been used.

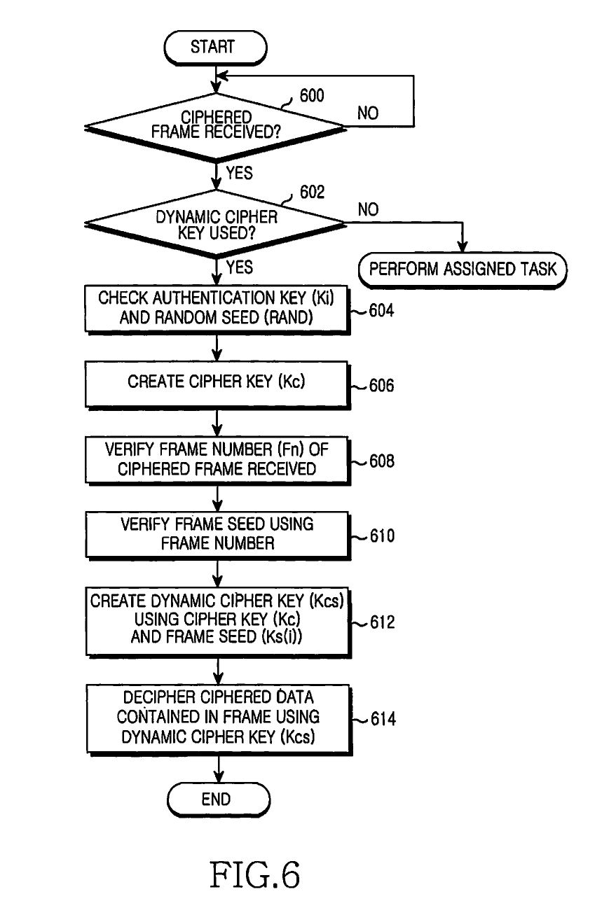

Referring to FIG. 6, the deciphering apparatus of the present invention, when it receives a ciphered frame at Step 600, proceeds to Step 602 to check dynamic cipher key usage information included in the header of the frame, thereby checking if the dynamic cipher key has been used. When the dynamic cipher key has not been used, it performs the assigned task.

If the dynamic cipher key has been used, the deciphering apparatus proceeds to Step 604 to verify the authentication key (Ki) and the random seed (RAND) transmitted to the ciphering apparatus to become the seed for cipher key creation. In Step 606, the deciphering apparatus creates the cipher key (Kc) according to the key creation algorithm using the authentication key (Ki) and the random seed (RAND). In Step 608, the deciphering apparatus verifies the frame number (Fn) of the ciphered frame. In Step 610, the deciphering apparatus obtains the frame seed (Ks(i)) corresponding to the frame number (Fn) using the SCT received from the authentication center. In Step 612, the deciphering apparatus creates the dynamic cipher key (Kcs) according to the key creation algorithm using the cipher key (Kc) and the frame seed (Ks(i)).

Then, the deciphering apparatus proceeds to Step 614 to decipher the ciphered data contained in the frame using the dynamic cipher key (Kcs).

As described above, the present invention relates to a dynamic ciphering apparatus and method, which dynamically creates cipher keys according to frame number of data when it is ciphered and transmitted in a ciphering apparatus of a mobile communication system, thereby enhancing the data security.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDS), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to a certain preferred embodiment thereof, it will be understood by those skilled in the art that various changes in form and details may be made therein without departing from the spirit and scope of the invention as further defined by the appended claims.

What is claimed is:

1. A dynamic ciphering mobile communication system, comprising:
a ciphering apparatus for receiving and storing a Security Code Table (SCT) beforehand, creating a dynamic cipher key using the SCT and frame number of data when the data to be transmitted needs to be ciphered, and transmitting a frame containing the data ciphered by the dynamic cipher key;
a deciphering apparatus for, creating a dynamic cipher key using the SCT and the frame number of the frame when the frame is received, and deciphers the data contained in the frame using the dynamic cipher key; and
an authentication center for managing an authentication key of authenticated information of subscribers, and creating and managing the SCT.

2. The dynamic ciphering mobile communication system of claim 1, wherein the authentication center, when re-asked for transmission of the SCT from the ciphering apparatus, does not transmit an existing SCT, rather creates a new SCT and transmits it to the ciphering apparatus and the deciphering apparatus.

3. A ciphering apparatus for a dynamic ciphering mobile communication system, comprising:
a dynamic key creation part for creating a dynamic cipher key that dynamically changes according to a frame number using an authentication key, a random seed received from a deciphering apparatus, the frame number of data to transmit, and an SCT; and
a ciphering part for creating ciphered data using the dynamic cipher key created by the dynamic key creation part.

4. The ciphering apparatus of claim 3, wherein the dynamic key creation part comprising:
a 1^{st} key creation part for creating cipher keys using the authentication key that identifies subscribers and the random seed that becomes the seed for cipher key creation,
the SCT, comprised of a set of random numbers, for obtaining a frame seed corresponding to the frame number; and
a 2^{nd} key creation part for creating the dynamic cipher key using the cipher key created by the 1^{st} key creation part and the frame seed obtained through the SCT.

5. The ciphering apparatus of claim 4, wherein the SCT obtains an index corresponding to the frame number by evaluating the following
Ks(i)=Code(Fn%X)
where Ks(i) represents the frame seed, X represents the total number of the index, Fn represents the frame number, and Code(i) represents the code value of the SCT corresponding to the i^{th} index.

6. The ciphering apparatus of claim 5, wherein the SCT is created and managed by the authentication center (AuC).

7. A deciphering apparatus for a dynamic ciphering mobile communication system, comprising:
a dynamic key creation part for creating a dynamic cipher key that dynamically changes according to frame number by use of an authentication key, a random seed transmitted to a ciphering apparatus, the frame number of frame received, and an SCT; and
a deciphering part for deciphering the data contained in the frame received using the dynamic cipher key created by the dynamic key creation part.

8. The deciphering apparatus of claim 7, wherein the dynamic key creation part comprises:
a 1^{st} key creation part for creating cipher keys using the authentication key that identifies subscribers and the random seed that becomes the seed for cipher key creation,
the SCT, comprised of a set of random numbers, for obtaining a frame seed corresponding to the frame number; and
a 2^{nd} key creation part for creating the dynamic cipher key according to the key creation algorithm using the cipher key created by the 1^{st} key creation part and the frame seed obtained through the SCT.

9. The deciphering apparatus of claim 8, wherein the SCT obtains an index corresponding to the frame number by evaluating the following
Ks(i)=Code(Fn%X)
where Ks(i) represents the frame seed, X represents the total number of index, Fn represents the frame number, and Code(i) represents the code value of the SCT corresponding to the i^{th} index.

10. The deciphering apparatus of claim 9, wherein the SCT is created and managed by the authentication center (Auc).

11. A dynamic ciphering method for a dynamic ciphering mobile communication system, comprising:
checking a stored authentication key and a random seed received from a deciphering apparatus when a data transmission event is sensed;
creating a cipher key using the authentication key and the random seed;
checking frame number of data to be transmitted;
obtaining a frame seed corresponding to the frame number using a stored SCT;
creating a dynamic cipher key using the cipher key and the frame seed;
creating ciphered data using the dynamic cipher key; and
creating and transmitting the frame containing the ciphered data.

12. The dynamic ciphering method of claim 11, wherein creating and transmitting the frame containing the ciphered data further comprises:
inserting dynamic cipher key usage information that indicates the dynamic cipher key has been used in a header of the frame at the time of creation of the frame.

13. The dynamic ciphering method of claim 11 wherein the obtaining the frame seed corresponding to the frame number using the stored SCT, comprises:
obtaining an index corresponding to the frame number by evaluating the following
Ks(i)=Code(Fn%X)
where, Ks(i) represents the frame seed, X represents the total number of index, Fn represents the frame number, and Code(i) represents the code value of the SCT corresponding to the i^{th} index.

14. The dynamic ciphering method of claim 13, wherein the SCT is received from the authentication center (AuC) and stored.

15. A dynamic deciphering method for a dynamic ciphering mobile communication system, comprising:
checking if a dynamic cipher key has been used when a frame is received;
checking an authentication key of a subscriber who transmitted the frame if the dynamic key has been used, and a random seed that has been created with random numbers and transmitted to a ciphering apparatus;
creating a cipher key using the authentication key and the random seed;
checking frame number of the frame received;
obtaining the frame seed corresponding to the frame number using a stored SCT;
creating a dynamic cipher key using the cipher key and the frame seed; and
deciphering the data contained in the frame received using the dynamic cipher key.

16. The dynamic deciphering method of claim 15, wherein the checking if the dynamic cipher key has been used, comprises:
checking dynamic cipher key usage information contained in a header of the frame.

17. The dynamic deciphering method of claim 15, wherein the obtaining the frame seed corresponding to the frame number using the stored SCT, comprises:
obtaining an index corresponding to the frame number by evaluating the following
Ks(i)=Code(Fn%X)
where, Ks(i) represents frame seed, X represents the total number of index, Fn represents the frame number, and Code(i) represents the code value of the SCT corresponding to the i^{th} index.

18. The dynamic deciphering method of claim 15, wherein the authentication key and the SCT are stored after being received from the authentication center (AuC).
